(19) United States
(12) Patent Application Publication
(10) Pub. No.: US 2015/0259571 A1
(43) Pub. Date: Sep. 17, 2015

(54) LIGNIN MEMBRANES AND COATINGS

(71) Applicant: EMPIRE TECHNOLOGY DEVELOPMENT LLC, Wilmington, DE (US)

(72) Inventor: Vincenzo Casasanta, III, Woodinville, WA (US)

(21) Appl. No.: 14/424,983

(22) PCT Filed: May 17, 2013
(86) PCT No.: PCT/US13/41539

§ 371 Date: Feb. 27, 2015

Related U.S. Application Data
(60) Provisional application No. 61/695,647, filed on Aug. 31, 2012.

(51) Int. Cl. C09D 197/02; C09D 103/02; C09D 197/00; C09D 101/02; B05D 1/18; B05D 3/00

(52) U.S. Cl. CPC C09D 197/02; B05D 1/18; B05D 3/007; C09D 197/005; C09D 101/02; C09D 103/02

(57) ABSTRACT

Described herein are hydrophilic biopolymer coatings, films, and membranes, methods for coating a substrate with a hydrophilic biopolymer coating and methods for producing hydrophilic biopolymer films and membranes.

### CLAIM OF PRIORITY

The present application claims the benefit of and priority to U.S. Provisional Application Ser. No. 61/695,647, entitled “Lignin Membranes and Coatings,” which application was filed on Aug. 31, 2012. The aforementioned application is incorporated by reference herein in its entirety and for all purposes.

### BACKGROUND

The industrial, protective and decorative coating industries are very large markets and have largely depended on the availability of raw materials from the petrochemicals industry. An increase in the demand for environmentally friendly and sustainable products, together with the growing uncertainty of the variable and volatile petrochemical market, has created the need for inexpensive, environmentally friendly, coatings and membranes for the industrial, protective and decorative coating industries.

### SUMMARY

Some embodiments described herein are directed to a method of coating a substrate with a biopolymer coating, the method comprising: dissolving a biopolymer in an ionic liquid solvent to form a single phase biopolymer solution; adding a phase separation solvent to the single phase biopolymer solution to form a colloid suspension of biopolymer aggregates; separating the colloid suspension of biopolymer aggregates from the ionic liquid solvent; depositing the biopolymer aggregates onto the substrate to form a coated substrate; and curing the coated substrate.

Some embodiments described herein are directed to a method of producing a hydrophilic biopolymer membrane, the method comprising: dissolving a biopolymer in an ionic liquid solvent to form a single phase biopolymer solution; adding a phase separation solvent to the single phase biopolymer solution to form a colloid suspension of biopolymer aggregates; separating the colloid suspension of biopolymer aggregates from the ionic liquid solvent; depositing the biopolymer aggregates onto the substrate to form a substrate coated with a deposited colloid suspension of biopolymer aggregates; and curing the substrate coated with a deposited colloid suspension of biopolymer aggregates to form the hydrophilic biopolymer membrane; and peeling away the hydrophilic biopolymer membrane from the substrate.

Some embodiments described herein are directed to a hydrophilic biopolymer coating comprising a cured colloid suspension of biopolymer aggregates. In some embodiments, the biopolymer aggregates comprise lignin, lignosulfonate, cellulose, sulfonated cellulose, hemicellulose, sulfonated hemicellulose, dextrin, sulfonated dextrin, a wood-derived biopolymer, a sulfonated wood-derived biopolymer or a combination thereof. In some embodiments, the biopolymer aggregates have a polydisperse molecular weight of about 500 Daltons to about 500,000 Daltons. In some embodiments, the biopolymer aggregates are bonded to each other via ether crosslinks.

Some embodiments described herein are directed to a hydrophilic biopolymer coating comprising a cured colloid suspension of biopolymer aggregates. In some embodiments, the biopolymer aggregates comprise lignin, lignosulfonate, cellulose, sulfonated cellulose, hemicellulose, sulfonated hemicellulose, dextrin, sulfonated dextrin, a wood-derived biopolymer, a sulfonated wood-derived biopolymer or a combination thereof. In some embodiments, the biopolymer aggregates have a polydisperse molecular weight of about 500 Daltons to about 500,000 Daltons. In some embodiments, the biopolymer aggregates are bonded to each other via ether crosslinks.

Some embodiments described herein are directed to a substrate coated with a hydrophilic biopolymer coating comprising a cured colloid suspension of biopolymer aggregates. In some embodiments, the biopolymer aggregates are bonded to the substrate via Van der Waals bonding, hydrogen bonding or a combination thereof.

### DETAILED DESCRIPTION

In the present disclosure, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figure, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

While various compositions, methods and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 substituents refers to groups having 1, 2, or 3 substituents. Similarly, a group having 1-5 substituents refers to groups having 1, 2, 3, 4, or 5 substituents, and so forth.

As used herein, a “colloid” refers to a substance microscopically dispersed evenly throughout another substance. As used herein, a “colloid suspension” refers to a homogenous continuous phase in which the colloid is dispersed.

As used herein, “ionic liquids” are intended to mean molten salts with di-functionalized imidazolium cations coupled with a broad range of ions of the general formula:

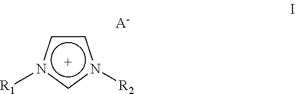

Wherein, R₁ and R₂ are independently, but not limited to, alkyl chains of varying lengths, a hydrogen, a C₁ to C₂₀ alkyl, a C₁ to C₂₀ alkene, C₁ to C₂₀ alcohol, a cyano, a benzyl, a methoxy benzyl, an alkoxyalkane. In some embodiments, R₁ and R₂ are independently, hydrogen, methyl, cyano, ethyl, allyl, propyl, butyl, pentyl, hexyl, heptyl, octyl, nonyl, decyl, tetradecyl, benzyl, methoxbenzyl, isopropyl, 3,6,-dioahexyl, 3,6,-dioxaheptyl, 3,6,9-trioxanonyl, 3,6,9-trioxadecyl, 4,8,12-trioxatridecyl, 3,6,9,12-tetraoxatridecyl, or 3,6,9,12,15,18,21-heptaoxadococyl. and wherein A⁻ is an anion selected from methylsulfate, trifluoromethanesulfonate, dimethylphosphate, bromide, fluoride, chloride, iodide, acetate, trifluoro acetate, methylphosphonate, dimethylphosphonate, diethylphosphate, ethylsulfate, tetrafluoroborate, tosylate, a dialkkylbenzenesulfonate, a bis[(trifluoromethane)sulfonyl]imide, formate, thiocyanate, dicyanamide, hexafluorphsophate, trifluoromethanesulfonate, dichloroaluminate, hydrogensulfate, lactate, sacharinate or a combination thereof.

In some embodiments, “ionic liquids” are intended to mean molten salts with di-functionalized imidazolium cations coupled with a broad range of ions of the general formula:

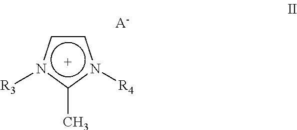

Wherein, R₃ and R₄ are independently, but not limited to, alkyl chains of varying lengths, a hydrogen, a C₁ to C₂₀ alkyl, a C₁ to C₂₀ alkene, C₁ to C₂₀ alcohol, a cyano, a benzyl, a methoxy benzyl, an alkoxyalkane and wherein A⁻ is an anion selected from methylsulfate, trifluoromethanesulfonate, dimethylphosphate, bromide, fluoride, chloride, iodide, acetate, trifluoro acetate, methylphosphonate, dimethylphosphonate, diethylphosphate, ethylsulfate, tetrafluoroborate, tosylate, a dialkkylbenzenesulfonate, a bis[(trifluoromethane)sulfonyl]imide, formate, thiocyanate, dicyanamide, hexafluorphsophate, trifluoromethanesulfonate, dichloroaluminate, hydrogensulfate, lactate, sacharinate or a combination thereof. In some embodiments, R₃ and R₄ are independently hydrogen, methyl, cyano, ethyl, allyl, propyl, butyl, pentyl, hexyl, heptyl, octyl, nonyl, decyl, tetradecyl, benzyl, methoxbenzyl, isopropyl, 3,6,-dioahexyl, 3,6,-dioxaheptyl, 3,6,9-trioxanonyl, 3,6,9-trioxadecyl, 4,8,12-trioxatridecyl, 3,6,9,12-tetraoxatridecyl, or 3,6,9,12,15,18,21-heptaoxadococyl. In some embodiments, R₃ or R₄ can be another di-functionalized imidazolium cation wherein the di-functionalized imidazolium cations are covalently linked via an alkyl chain.

In some embodiments, “ionic liquids” are intended to mean molten salts with di-functionalized pyrrolidinium cations coupled with a broad range of ions of the general formula:

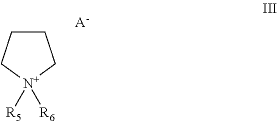

Wherein, R₅ and R₆ are independently, but not limited to, alkyl chains of varying lengths, a hydrogen, a C₁ to C₂₀ alkyl, a C₁ to C₂₀ alkene, C₁ to C₂₀ alcohol, a cyano, a benzyl, a methoxy benzyl, an alkoxyalkane. In some embodiments, R₅ and R₆ are independently hydrogen, methyl, cyano, ethyl, allyl, propyl, butyl, pentyl, hexyl, heptyl, octyl, nonyl, decyl, tetradecyl, benzyl, methoxbenzyl, isopropyl, 3,6,-dioahexyl, 3,6,-dioxaheptyl, 3,6,9-trioxanonyl, 3,6,9-trioxadecyl, 4,8,12-trioxatridecyl, 3,6,9,12-tetraoxatridecyl, or 3,6,9,12,15,18,21-heptaoxadococyl. and wherein A⁻ is an anion selected from methylsulfate, trifluoromethanesulfonate, dimethylphosphate, bromide, fluoride, chloride, iodide, acetate, trifluoro acetate, methylphosphonate, dimethylphosphonate, diethylphosphate, ethylsulfate, tetrafluoroborate, tosylate, a dialkkylbenzenesulfonate, a bis[(trifluoromethane)sulfonyl]imide, formate, thiocyanate, dicyanamide, hexafluorphsophate, trifluoromethanesulfonate, dichloroaluminate, hydrogensulfate, lactate, sacharinate or a combination thereof.

In some embodiments, “ionic liquids” are intended to mean molten salts with quad-functionalized cations coupled with a broad range of ions of the general formula:

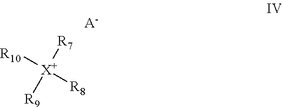

Wherein X is selected from Nitrogen or phosphorous and wherein, R₇, R₈, R₉ and R₁₀ are independently, but not limited to, alkyl chains of varying lengths, a hydrogen, a C₁ to C₂₀ alkyl, a C₁ to C₂₀ alkene, C₁ to C₂₀ alcohol, a cyano, a benzyl, a methoxy benzyl, an alkoxyalkane. In some embodiments, R₇, R₈, R₉ and R₁₀ are independently hydrogen, methyl, cyano, ethyl, allyl, propyl, butyl, pentyl, hexyl, heptyl, octyl, nonyl, decyl, tetradecyl, benzyl, methoxbenzyl, isopropyl, 3,6,-dioahexyl, 3,6,-dioxaheptyl, 3,6,9-trioxanonyl, 3,6,9-trioxadecyl, 4,8,12-trioxatridecyl, 3,6,9,12-tetraoxatridecyl, or 3,6,9,12,15,18,21-heptaoxadococyl. and wherein A⁻ is an anion selected from methylsulfate, trifluoromethanesulfonate, dimethylphosphate, bromide, fluoride, chloride, iodide, acetate, trifluoro acetate, methylphosphonate, dimethylphosphonate, diethylphosphate, ethylsulfate, tetrafluoroborate, tosylate, a dialkkylbenzenesulfonate, a bis[(trifluoromethane)sulfonyl]imide, formate, thiocyanate, dicyanamide, hexafluorphsophate, trifluoromethanesulfonate, dichloroaluminate, hydrogensulfate, lactate, sacharinate or a combination thereof.

In some embodiments, “ionic liquids” are intended to mean molten salts with di-functionalized 1,8-diazabicyclo[5.4.0]undec-7-enium cations coupled with a broad range of ions of the general formula:

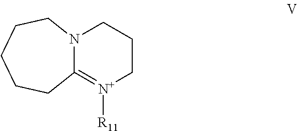

Wherein X is selected from Nitrogen or phosphorous and wherein, R₁₁ is selected from, but not limited to, alkyl chains of varying lengths, a hydrogen, a C₁ to C₂₀ alkyl, a C₁ to C₂₀ alkene, C₁ to C₂₀ alcohol, a cyano, a benzyl, a methoxy benzyl, an alkoxyalkane. In some embodiments, R₁₁ is hydrogen, methyl, cyano, ethyl, allyl, propyl, butyl, pentyl, hexyl, heptyl, octyl, nonyl, decyl, tetradecyl, benzyl, methoxbenzyl, isopropyl, 3,6,-dioahexyl, 3,6,-dioxaheptyl, 3,6,9-trioxanonyl, 3,6,9-trioxadecyl, 4,8,12-trioxatridecyl, 3,6,9,12-tetraoxatridecyl, or 3,6,9,12,15,18,21-heptaoxadococyl. and wherein A⁻ is an anion selected from methylsulfate, trifluoromethanesulfonate, dimethylphosphate, bromide, fluoride, chloride, iodide, acetate, trifluoro acetate, methylphosphonate, dimethylphosphonate, diethylphosphate, ethylsulfate, tetrafluoroborate, tosylate, a dialkkylbenzenesulfonate, a bis[(trifluoromethane)sulfonyl]imide, formate, thiocyanate, dicyanamide, hexafluorphsophate, trifluoromethanesulfonate, dichloroaluminate, hydrogensulfate, lactate, sacharinate or a combination thereof.

In some embodiments, “ionic liquids” are intended to mean molten salts with di-functionalized pyridinium cations coupled with a broad range of ions of the general formula:

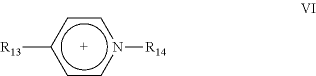

Wherein, R₁₃ and R₁₄ are independently selected from, but not limited to, alkyl chains of varying lengths, a hydrogen, a C₁ to C₂₀ alkyl, a C₁ to C₂₀ alkene, C₁ to C₂₀ alcohol, a cyano, a benzyl, a methoxy benzyl, an alkoxyalkane. In some embodiments, R₁₃ and R₁₄ are independently hydrogen, methyl, cyano, ethyl, allyl, propyl, butyl, pentyl, hexyl, heptyl, octyl, nonyl, decyl, tetradecyl, benzyl, methoxbenzyl, isopropyl, 3,6,-dioahexyl, 3,6,-dioxaheptyl, 3,6,9-trioxanonyl, 3,6,9-trioxadecyl, 4,8,12-trioxatridecyl, 3,6,9,12-tetraoxatridecyl, or 3,6,9,12,15,18,21-heptaoxadococyl. and wherein A⁻ is an anion selected from methylsulfate, trifluoromethanesulfonate, dimethylphosphate, bromide, fluoride, chloride, iodide, acetate, trifluoro acetate, methylphosphonate, dimethylphosphonate, diethylphosphate, ethylsulfate, tetrafluoroborate, tosylate, a dialkkylbenzenesulfonate, a bis[(trifluoromethane)sulfonyl]imide, formate, thiocyanate, dicyanamide, hexafluorphsophate, trifluoromethanesulfonate, dichloroaluminate, hydrogensulfate, lactate, sacharinate or a combination thereof.

In some embodiments, ionic liquids comprise 1,3-dimethylimidazolium methylsulfate, 1,3-dimethylimidazolium dimethylphosphate, 1-cyano-3-methylimidazolium bromide, 1-ethyl-3-methylimidazolium fluoride, 1-ethyl-3-methylimidazolium chloride, 1-ethyl-3-methylimidazolium bromide, 1-ethyl-3-methylimidazolium acetate, 1-ethyl-3-methylimidazolium methylphosphonate, 1-ethyl-3-methylimidazolium dimethylphosphonate, 1-ethyl-3-methylimidazolium dimethylphosphate, 1-ethyl-3-methylimidazolium diethylphosphate, 1-ethyl-3-methylimidazolium ethylsulfate, 1-ethyl-3-methylimidazolium tetrafluoroborate, 1-ethyl-3-methylimidazolium tosylate, 1-ethyl-3-methylimidazolium dialkylbenzenesulfonate, 1-ethyl-3-methylimidazolium bis[(trifluoromethane)sulfonyl]imide, 1-allyl-3-methylimadazolium formate, 1-ally-3-methylimidazolium chloride, 1-propyl-3-methylimidazolium chloride, 1-propyl-3-methylimidazolium bromide, 1-butyl-3-methylimidazolium chloride, 1-butyl-3-methylimidazolium bromide, 1-butyl-3-methylimidazolium iodide, 1-butyl-3-methylimidazolium formate, 1-butyl-3-methylimidazolium thiocyanate, 1-butyl-3-methylimidazolium dicyanamide, 1-butyl-3-methylimidazolium acetate, 1-butyl-3-methylimidazolium tetrafluoroborate, 1-butyl-3-methylimidazolium hexfluorophosphate, 1-butyl-3-methylimidazolium trifluoromethanesulfonate, 1-butyl-3-methylimidazolium methylsulfate, 1-butyl-3-methylimidazolium bis[(trifluoromethane)sulfonyl]imide, 1-butyl-2,3-dimethylimidazolium chloride, 1-butyl-2,3-dimethylimidazolium tetrafluoroborate, 1-pentyl-3-methylimidazolium chloride, 1-pentyl-3-methylimidazolium bromide, 1-hexyl-3-methylimidazolium chloride, 1-hexyl-3-methylimidazolium bromide, 1-hexyl-3-methylimidazolium tetrafluoroborate, 1-hexyl-3-methylimidazolium trifluoromethanesulfonate, 1-hexyl-3-methylimidazolium bis[(trifluoromethane)sulfonyl]imide, 1-heptyl-3-methylimidazolium chloride, 1-heptyl-3-methylimidazolium bromide, 1-octyl-3-methylimidazolium chloride, 1-octyl-3-methylimidazolium bromide, 1-octyl-3-methylimidazolium acetate, 1-nonl-3-methylimidazolium chloride, 1-nonyl-3-methylimidazolium bromide, 1-decyl-3-methylimidazolium chloride, 1-benzyl-3-methylimidazolium chloride, 1-benzyl-3-methylimidazolium dicyanamide, 1-(3-methoxybenzyl)-3-methylimidazolium chloride, 1-(3,6-dioxahexyl)-3-methylimidazolium chloride, 1-(3,6-dioxahexyl)-3 methylimidazolium acetate, 1-ethyl-3-(3,6-dioxaheptyl)imidazolium chloride, 1-ethyl-3-(3,6-dioxaheptyl)imidazolium dicyanamide, 1-ethyl-3-(3,6-dioxaheptyl)imidazolium acetate, 1(3,6,9-trioxanoyl)-3-methylimidazolium acetate, 1-ethyl-3-(3,6,9-trioxadecyl)imidazolium acetate, 1-butyl-3-(3,6,9-trioxadecyl)imidazolium acetate, 1-ethyl-3-(4,8,12-trioxatridecyl)imidazolium acetate, 1-ethyl-3(3,6,9,12-tetraoxatridecyl)imidazolium acetate, 1-(3,6-dioxaheptyl)-3-(3,6,9-trioxadecyl)imidazolium acetate, 1-ethyl-3(3,6,9,12,15,18,21-heptaoxadococyl)imidazolium acetate, 3,3′-ethane-1,2-diylbis(1-methyl-1H-imidazol-3-ium)dichloride, 3,3′-ethane-1,2-diylbis(1-methyl-1H-imidazol-3-ium)dichloroaluminate, 1-butyl-1-methylpyrrolidinium chloride, 1-butyl-1-methylpyrrolidinium bis[(trifluoromethane)sulfonyl]imide, 1-butyl-3-methylpyridinium chloride, N.N-dimethylathanolammonium acetate, choline dicyanamide, choline bis[(trifluoromethane)sulfonyl]imide, N.N-dimethyl-2-methoxyethylammonium acetate, N.N-bis(2-methoxyethyl)ammonium acetate, N-methyl-N.N-bis(2-methoxyethyl)ammonium acetate, N.N.N-triethyl-3,6-dioxaheptylammonium acetate, tetrabutylammonium formate, N.N.N-triethyl-3,6,9-trioxadecylammonium formate, N.N.N-triethyl-3,6,9-trioxadecylammonium acetate, N-benzyl-N,N-dimethyltretradecylammonium chloride, tetrabutylphosphonium chloride, tetrabutylphosphonium formate, trihexyltetradecylphosphonium dicyanamide, 1,8-diazabicyclo[5.4.0]undec-7-enium hydrochloride, 1,8-diazabicyclo[5.4.0]undec-7-enium formate, 1,8-diazabicyclo[5.4.0]undec-7-enium acetate, 1,8-diazabicyclo[5.4.0]undec-7-enium thiocyanate, 1,8-diazabicyclo[5.4.0]undec-7-enium hydrogensulfate, 1,8-diazabicyclo[5.4.0]undec-7-enium trifluoroacetate, 1,8-diazabicyclo[5.4.0]undec-7-enium methanesulfonate, 1,8-diazabicyclo[5.4.0]undec-7-enium lactate, 1,8-diazabicyclo[5.4.0]undec7-enium tosylate, 1,8-diazabicyclo[5.4.0]undec-7-enium saccharinate, 1,8-diazabicyclo[5.4.0]undec-7-enium, 8-methyl-1,8-diazabicyclo[5.4.0]undec-7-enium hydrogensulfate, 8-butyl-1,8-diazabicyclo[5.4.0]undec-7-enium chloride, 8-octyl-1,8-diazabicyclo[5.4.0]undec-7-enium chloride or a combination thereof.

At ambient temperature and pressure, Ionic liquids behave much like molten salt electrolytes. In some embodiments, ionic liquids can be used to degrade solid biopolymers into a colloidal suspension and then electrophoretically depositing the colloid suspension to produce a hydrophilic organic coating.

Some embodiments described herein are directed to a method of coating a substrate with a biopolymer coating, the method comprising: dissolving a biopolymer in an ionic liquid solvent to form a single phase biopolymer solution; adding a phase separation solvent to the single phase biopolymer solution to form a colloid suspension of biopolymer aggregates; separating the colloid suspension of biopolymer aggregates from the ionic liquid solvent; depositing the biopolymer aggregates onto the substrate to form a coated substrate; and curing the coated substrate.

In some embodiments, the biopolymer comprises lignin, lignosulfonate, cellulose, sulfonated cellulose, hemicellulose, sulfonated hemicellulose, dextrin, sulfonated dextrin, a wood-derived biopolymer, a sulfonated wood-derived biopolymer or a combination thereof. In some embodiments, the biopolymer has a polydisperse molecular weight average of about 500 Daltons to about 500,000 Daltons.

Lignin has a tenacious phenolic structure akin to phenol formaldehyde or cresol-formaldehyde based resins. In the past phenolic resins were one of the major sources of structural polymers. Much of lignin's natural strength is due to the phenolic ether linkages and much of the structural integrity of plant life is due to the expansive three-dimensional covalent network intrinsic to lignocellulosic structure. In processes that produce excess lignin (such as second generation bio-refineries) its chemical and structural tenacity combined with its high energy density instigate many processing facilities to simply burn it for energy. This structural robustness of lignin has promoted the inclusion of lignin in coatings whereby it is mechanically processed (pulverized, shredded, etc.) and simply used as a filler. In some embodiments, new solvents for lignocellulosic biomass can be used to formulate completely new lignin applications. In some embodiments, lignin can be molecularly broken down and reassembled to form a material as structurally stable as in its natural state, creating new class of robust and “green”/environmentally friendly coatings.

As shown below, the general structure of lignin includes a number of phenolic hydroxyl and methoxy functional end groups:

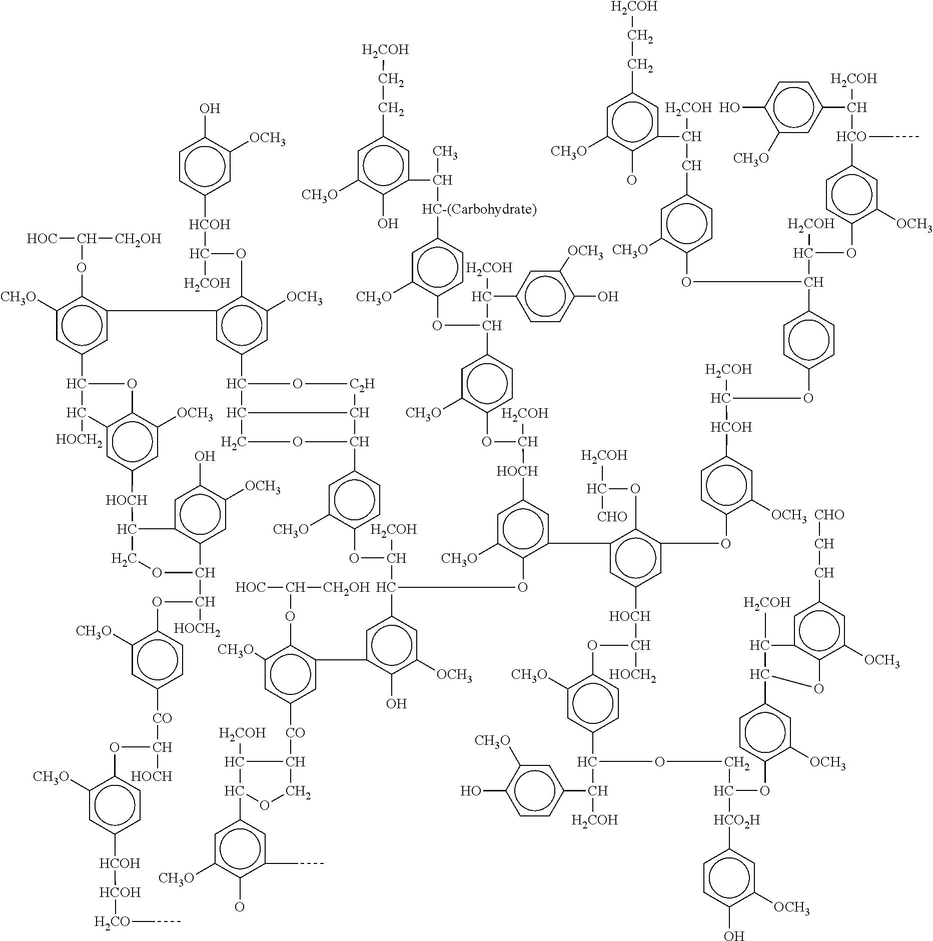

In some embodiments, dissolution of the biopolymer in the ionic liquid solvent does not induce covalent derivatization, that is, it does not induce breakage of covalent bonds. In some embodiments, dissolving the biopolymer in an ionic liquid solvent comprises immersing the biopolymer in the ionic liquid solvent to form the single phase biopolymer solution. In some embodiments, the biopolymer is a powder prior to being dissolved in the ionic liquid solvent. In some embodiments, the biopolymer is a paste prior to being dissolved in the ionic liquid solvent.

In some embodiments, the ionic liquid solvent comprises at least one di-functionalized imidazolium salt. In some embodiments, the di-functionalized imidazolium salt is selected from 1,3,dimethylimidazolium methylsulfate, 1-hexyl-3-methylimidazolium trifluoromethanesulfonate, 1-butyl-3-methylimidazolium methylsulfate or a combination thereof.

In some embodiments, the ionic liquid solvent comprises at least one of 1,3-dimethylimidazolium methylsulfate, 1,3-dimethylimidazolium dimethylphosphate, 1-cyano-3-methylimidazolium bromide, 1-ethyl-3-methylimidazolium fluoride, 1-ethyl-3-methylimidazolium chloride, 1-ethyl-3-methylimidazolium bromide, 1-ethyl-3-methylimidazolium acetate, 1-ethyl-3-methylimidazolium methylphosphonate, 1-ethyl-3-methylimidazolium dimethylphosphonate, 1-ethyl-3-methylimidazolium dimethylphosphate, 1-ethyl-3-methylimidazolium diethylphosphate, 1-ethyl-3-methylimidazolium ethylsulfate, 1-ethyl-3-methylimidazolium tetrafluoroborate, 1-ethyl-3-methylimidazolium tosylate, 1-ethyl-3-methylimidazolium dialkylbenzenesulfonate, 1-ethyl-3-methylimidazolium bis[(trifluoromethane)sulfonyl]imide, 1-allyl-3-methylimadazolium formate, 1-ally-3-methylimidazolium chloride, 1-propyl-3-methylimidazolium chloride, 1-propyl-3-methylimidazolium bromide, 1-butyl-3-methylimidazolium chloride, 1-butyl-3-methylimidazolium bromide, 1-butyl-3-methylimidazolium iodide, 1-butyl-3-methylimidazolium formate, 1-butyl-3-methylimidazolium thiocyanate, 1-butyl-3-methylimidazolium dicyanamide, 1-butyl-3-methylimidazolium acetate, 1-butyl-3-methylimidazolium tetrafluoroborate, 1-butyl-3-methylimidazolium hexfluorophosphate, 1-butyl-3-methylimidazolium trifluoromethanesulfonate, 1-butyl-3-methylimidazolium methylsulfate, 1-butyl-3-methylimidazolium bis[(trifluoromethane)sulfonyl]imide, 1-butyl-2,3-dimethylimidazolium chloride, 1-butyl-2,3-dimethylimidazolium tetrafluoroborate, 1-pentyl-3-methylimidazolium chloride, 1-pentyl-3-methylimidazolium bromide, 1-hexyl-3-methylimidazolium chloride, 1-hexyl-3-methylimidazolium bromide, 1-hexyl-3-methylimidazolium tetrafluoroborate, 1-hexyl-3-methylimidazolium trifluoromethanesulfonate, 1-hexyl-3-methylimidazolium bis[(trifluoromethane)sulfonyl]imide, 1-heptyl-3-methylimidazolium chloride, 1-heptyl-3-methylimidazolium bromide, 1-octyl-3-methylimidazolium chloride, 1-octyl-3-methylimidazolium bromide, 1-octyl-3-methylimidazolium acetate, 1-nonl-3-methylimidazolium chloride, 1-nonyl-3-methylimidazolium bromide, 1-decyl-3-methylimidazolium chloride, 1-benzyl-3-methylimidazolium chloride, 1-benzyl-3-methylimidazolium dicyanamide, 1-(3-methoxybenzyl)-3-methylimidazolium chloride, 1-(3,6-dioxahexyl)-3-methylimidazolium chloride, 1-(3,6-dioxahexyl)-3 methylimidazolium acetate, 1-ethyl-3-(3,6-dioxaheptyl)imidazolium chloride, 1-ethyl-3-(3,6-dioxaheptyl)imidazolium dicyanamide, 1-ethyl-3-(3,6-dioxaheptyl)imidazolium acetate, 1(3,6,9-trioxanoyl)-3-methylimidazolium acetate, 1-ethyl-3-(3,6,9-trioxadecyl)imidazolium acetate, 1-butyl-3-(3,6,9-trioxadecyl)imidazolium acetate, 1-ethyl-3-(4,8,12-trioxatridecyl)imidazolium acetate, 1-ethyl-3(3,6,9,12-tetraoxatridecyl)imidazolium acetate, 1-(3,6-dioxaheptyl)-3-(3,6,9-trioxadecyl)imidazolium acetate, 1-ethyl-3(3,6,9,12,15,18,21-heptaoxadococyl)imidazolium acetate, 3,3′-ethane-1,2-diylbis(1-methyl-1H-imidazol-3-ium)dichloride, 3,3′-ethane-1,2-diylbis(1-methyl-1H-imidazol-3-ium)dichloroaluminate, 1-butyl-1-methylpyrrolidinium chloride, 1-butyl-1-methylpyrrolidinium bis[(trifluoromethane)sulfonyl]imide, 1-butyl-3-methylpyridinium chloride, N.N-dimethylathanolammonium acetate, choline dicyanamide, choline bis[(trifluoromethane)sulfonyl]imide, N.N-dimethyl-2-methoxyethylammonium acetate, N.N-bis(2-methoxyethyl)ammonium acetate, N-methyl-N.N-bis(2-methoxyethyl)ammonium acetate, N.N.N-triethyl-3,6-dioxaheptylammonium acetate, tetrabutylammonium formate, N.N.N-triethyl-3,6,9-trioxadecylammonium formate, N.N.N-triethyl-3,6,9-trioxadecylammonium acetate, N-benzyl-N,N-dimethyltretradecylammonium chloride, tetrabutylphosphonium chloride, tetrabutylphosphonium formate, trihexyltetradecylphosphonium dicyanamide, 1,8-diazabicyclo[5.4.0]undec-7-enium hydrochloride, 1,8-diazabicyclo[5.4.0]undec-7-enium formate, 1,8-diazabicyclo[5.4.0]undec-7-enium acetate, 1,8-diazabicyclo[5.4.0]undec-7-enium thiocyanate, 1,8-diazabicyclo[5.4.0]undec-7-enium hydrogensulfate, 1,8-diazabicyclo[5.4.0]undec-7-enium trifluoroacetate, 1,8-diazabicyclo[5.4.0]undec-7-enium methanesulfonate, 1,8-diazabicyclo[5.4.0]undec-7-enium lactate, 1,8-diazabicyclo[5.4.0]undec7-enium tosylate, 1,8-diazabicyclo[5.4.0]undec-7-enium saccharinate, 1,8-diazabicyclo[5.4.0]undec-7-enium, 8-methyl-1,8-diazabicyclo[5.4.0]undec-7-enium hydrogensulfate, 8-butyl-1,8-diazabicyclo[5.4.0]undec-7-enium chloride, 8-octyl-1,8-diazabicyclo[5.4.0]undec-7-enium chloride or a combination thereof.

In some embodiments, the phase separation solvent is incrementally added to the single phase biopolymer solution to form the colloid suspension of biopolymer aggregates. In some embodiments, the size and amount of the colloids of biopolymer aggregates formed by addition of the phase separation solvent may depend on the rate of addition of the phase separation solvent, the polarity of the phase separation solvent, the terminal total volume percent of the biopolymer colloids of biopolymer aggregates or a combination thereof.

In some embodiments, the phase separation solvent is an aqueous solvent. In some embodiments, the phase separation solvent is water. In some embodiments, the phase separation solvent is an organic solvent. In some embodiments, the phase separation solvent is selected from ethanol, acetone, cyclohexane, toluene, methylethylketone, benzene, ethylene glycol, cyclopentanone or a combination thereof. In some embodiments, the phase separation solvent may be a combination of water and an organic solvent. In some embodiments, the phase separation solvent is any solvent suitable for electrophoretic deposition. In some embodiments, the phase separation solvent is any solvent capable of supporting an electromotive force. In some embodiments, the phase separation solvent is any solvent capable of supporting an electric current. In some embodiments, the phase separation solvent can be utilized to modify the overall polarity of the colloid suspension of biopolymer aggregates.

In some embodiments, addition of the phase separation solvent may result in the formation of the colloid suspension of biopolymer aggregates. In some embodiments, the formation of the colloid suspension of biopolymer aggregates results from a change in the solvents polarity, the hydrogen bonding environment in the solvent and Van Der Waals interactions. In some embodiments, the colloid suspension of biopolymer aggregates may develop a persistent net charge as they come out of the ionic liquid solvent phase. In some embodiments, addition of the phase separation solvent may result in the formation of two distinct liquid phases. In some embodiments some embodiments, the liquid phases comprise an ionic liquid solvent phase and a phase separation solvent phase. In some embodiments, the colloid suspension of biopolymer aggregates is contained in the phase separation solvent phase.

In some embodiments, separating the colloid suspension of biopolymer aggregates from the ionic liquid solvent comprises sedimentation, solidification or a combination thereof. In some embodiments, standard methods of sedimentation or solidification can be used.

In some embodiments, the substrate is a metallic substrate comprising at least one of copper, annealed copper, aluminum, tungsten, nickel, platinum, gold, silver, brass, bronze, iron, steel, stainless steel, grain oriented electrical steel, lead, lithium, tin, titanium, mercury, cadmium, manganin, constatan, nichrome or a combination thereof.

In some embodiments, the substrate is a semiconductor comprising at least one of selenium, germanium, carbon, silicon, silicon carbide, aluminum antimonide, aluminum nitride, boron nitride, boron arsenide, gallium arsenide, gallium nitride, gallium phosphide, gallium antimonide, indium nitride, indium phosphide, indium antimonide, aluminum gallium arsenide, indium gallium arsenide, indium gallium phosphide, aluminum indium arsenide, aluminum indium antimonide, gallium arsenide nitride, gallium arsenide phosphide, gallium arsenide antimonide, aluminum gallium nitride, aluminum gallium phosphide, indium arsenide antimonide, indium gallium antimonide, aluminum gallium indium phosphide, aluminum gallium arsenide phosphate, indium gallium arsenide phosphide, indium gallium arsenide antimonide, indium arsenide antimonide phosphide, aluminum indium arsenide phosphide, aluminum gallium arsenide nitride, indium, gallium arsenide nitride, indium aluminum arsenide nitride, gallium arsenide antimonide nitride, gallium indium nitride arsenide antimonide, gallium indium arsenide antimonide phosphide, cadmium selenide, cadmium sulfide, cadmium telluride, zinc oxide, zinc selenide, zinc sulfide, zinc telluride, cadmium zinc telluride, mercury zinc telluride mercury zinc selenide, cuprous chloride, copper sulfide, lead selenide, lead(II) sulfide, lead telluride, lead tine telluride, thallium germanium telluride, bismuth telluride, cadmium phosphide, cadmium arsenide, cadmium antimonide, zinc phosphide, zinc arsenide, zinc antimonide, titanium dioxide, copper oxide, uranium dioxide uranium trioxide, bismuth trioxide, tin dioxide, barium titanate, strontium titanate, lithium niobate, lanthanum copper oxide, lead(II) iodide, molybdenum disulfide, gallium selenide, tin sulfide, bismuth sulfide, gallium manganese arsenide, indium manganese telluride, lanthanum calcium manganite, Iron(II) oxide, nickel(II) oxide, europium (II) oxide, europium(II) sulfide, chromium(III) bromide, copper indium gallium selenide, copper zinc tin sulfide, copper indium selenide, silver gallium sulfide, zinc silicon phosphide, arsenic sulfide, platinum silicide, bismuth(III) iodide, mercury(II) iodide, thallium(I) bromide, silver sulfide, iron disulfide, or a combination thereof.

In some embodiments, the substrate is a material capable of supporting an electromotive force. In some embodiments, the substrate is a material capable of supporting an electric current.

In some embodiments, the step of depositing the biopolymer aggregates onto the substrate comprises electrophoretic deposition. Electrophoretic deposition of organic and inorganic suspensions is commonly employed in high volume manufacturing to fix coatings onto metallic substrates such as paint deposition onto car bodies in the automobile industry.

In some embodiments, electrophoretic deposition of the colloid suspension of biopolymer aggregates onto the substrate comprises immersing the substrate and a counter electrode into the colloid suspension of biopolymer aggregates.

Some embodiments further comprise providing a source of electromotive force wherein the source has a first terminus and a second terminus and wherein an electrical potential exists between the first and the second terminus and wherein the first terminus is contacted to the substrate and wherein the second terminus is contacted to the counter electrode. In some embodiments, the source of electromotive force produces about 20 volts to about 400 volts. In some embodiments, the source of electromotive force produces about 20 to about 40 volts, about 40 to about 100 volts, about 100 volts to about 200 volts, about 200 volts to about 300 volts, or about 300 volts to about 400 volts.

In some embodiments, the counter electrode is biased as an anode and the substrate is biased as a cathode and wherein the colloid suspension of biopolymer aggregates has an overall positive charge resulting in deposition of the colloid suspension of biopolymer aggregates onto the substrate. In some embodiments, the counter electrode is biased as a cathode and the substrate is biased as an anode and wherein the colloid suspension of biopolymer aggregates has an overall negative charge resulting in deposition of the colloid suspension of biopolymer aggregates onto the substrate.

In some embodiments, as the source of electromotive force is applied, the colloids of biopolymer aggregates will migrate to the substrate and accumulate on the surface of the substrate as a coating. In some embodiments, the coating will adhere to the substrate as an electric field is created that involves the double layer of the substrate surface and the charged colloids of biopolymer aggregates. In some embodiments, the duration time of applied electromotive force will determine the coating thickness on the substrate. In some embodiments, the greater the duration of time of applied electromotive force, the thicker the coating on the substrate. In some embodiments, electrophoretic deposition results in formation of Van der Waals bonding, hydrogen bonding or a combination thereof between the biopolymer aggregates and the substrate. In some embodiments, electrophoretic deposition results in formation of Van der Waals bonding, hydrogen bonding or a combination thereof between the biopolymer aggregates.

In some embodiments, the thickness of the coatings described herein can be about 0.1 micron to about 1,000 micron. In yet other embodiments the thickness of the coatings can be about 0.1 microns to about 10 microns, about 10 microns to about 100 microns, about 100 microns to about 200 microns, about 200 microns to about 300 microns, about 300 microns to about 400 microns, or about 400 microns to about 500 microns, about 500 microns to about 600 microns, about 600 microns to about 700 microns, about 700 microns to about 800 microns, about 800 microns to about 900 microns, about 900 microns to about 1,000 microns.

Some embodiments further comprise removing the coated substrate from the colloid suspension of biopolymer aggregates following electrophoretic deposition of the biopolymer aggregates onto the substrate to form the coated substrate. Some embodiments further comprise rinsing the coated substrate. In some embodiments, the coated substrate is rinsed to remove any unbound biopolymer aggregates from the coated substrate. In some embodiments, the coated substrate is rinsed with water. In some embodiments, the coated substrate is rinsed with the phase separation solvent. Some embodiments further comprise drying the coated substrate. In some embodiments, the coated substrate is air dried.

In some embodiments, curing the coated substrate comprises heat treating the coated substrate. In some embodiments, the coated substrate may be cured using any technique known in the art, such as, without limitation, thermal energy, infrared, ionizing or actinic radiation, or by any combination thereof. In some embodiments, curing the coated substrate comprises heating the coated substrate to a temperature of up to about 130° C. In some embodiments, curing the coated substrate comprises heating the coated substrate to a temperature of up to about 25° C., about 50° C., about 75° C., or about 100° C. In some embodiments, the coated substrate may cure at ambient temperature. In some embodiments, curing the coated substrate is carried out for a period of 1 to 72 hours. In some embodiments, curing times be about 1 hour to about 12 hours, about 12 hours to about 24 hours, about 24 hours to about 36 hours, about 36 hours to about 48 hours, about 48 hours to about 60 hours, or about 60 hours to about 72 hours.

In some embodiments, the biopolymer aggregate coating may be porous prior to curing due to the formation of gas during the electrophoretic deposition process. In some embodiments, curing the coated substrate results in the formation of crosslinks and allows accumulated gas to flow out of the coating making it smooth and continuous. In some embodiments, curing the coated substrate results in the formation of ether crosslinks between the biopolymer aggregates. In some embodiments, the ether crosslinks are formed between hydroxyl functional end groups and methoxy functional end groups on the biopolymer aggregates. In some embodiments, not all hydroxyl functional end groups form ether crosslinks. In some embodiments, the degree of crosslinking can be about 1% to about 100%, about 1% to about 10%, about 10% to about 50%, or about 50% to about 100% of functional end groups being crosslinked. In some embodiments, water and methanol are byproducts of the formation of crosslinks between biopolymer aggregates. In some embodiments, ether crosslinks, hydroxyl functional end groups or a combination thereof form make the coating on the substrate hydrophilic.

Some embodiments described herein are directed to a method of producing a hydrophilic biopolymer membrane or film, the method comprising: dissolving a biopolymer in an ionic liquid solvent to form a single phase biopolymer solution; adding a phase separation solvent to the single phase biopolymer solution to form a colloid suspension of biopolymer aggregates; separating the colloid suspension of biopolymer aggregates from the ionic liquid solvent; depositing the biopolymer aggregates onto the substrate to form a substrate coated with a deposited colloid suspension of biopolymer aggregates; and curing the substrate coated with deposited colloid suspension of biopolymer aggregates to form the hydrophilic biopolymer membrane or film; and peeling away the hydrophilic biopolymer membrane or film from the substrate.

In some embodiments, the biopolymer comprises lignin, lignosulfonate, cellulose, sulfonated cellulose, hemicellulose, sulfonated hemicellulose, dextrin, sulfonated dextrin, a wood-derived biopolymer, a sulfonated wood-derived biopolymer or a combination thereof. In some embodiments, the biopolymer is of polydisperse molecular weights of about 500 Daltons to about 500,000 Daltons.

In some embodiments the ionic liquid solvent comprises at least one di-functionalized imidazolium salt. In some embodiments, the di-functionalized imidazolium salt is selected from 1,3,dimethylimidazolium methylsulfate, 1-hexyl-3-methylimidazolium trifluoromethanesulfonate, 1-butyl-3-methylimidazolium methylsulfate or a combination thereof.

In some embodiments, the ionic liquid solvent comprises at least one of 1,3-dimethylimidazolium methylsulfate, 1,3-dimethylimidazolium dimethylphosphate, 1-cyano-3-methylimidazolium bromide, 1-ethyl-3-methylimidazolium fluoride, 1-ethyl-3-methylimidazolium chloride, 1-ethyl-3-methylimidazolium bromide, 1-ethyl-3-methylimidazolium acetate, 1-ethyl-3-methylimidazolium methylphosphonate, 1-ethyl-3-methylimidazolium dimethylphosphonate, 1-ethyl-3-methylimidazolium dimethylphosphate, 1-ethyl-3-methylimidazolium diethylphosphate, 1-ethyl-3-methylimidazolium ethylsulfate, 1-ethyl-3-methylimidazolium tetrafluoroborate, 1-ethyl-3-methylimidazolium tosylate, 1-ethyl-3-methylimidazolium dialkylbenzenesulfonate, 1-ethyl-3-methylimidazolium bis[(trifluoromethane)sulfonyl]imide, 1-allyl-3-methylimadazolium formate, 1-ally-3-methylimidazolium chloride, 1-propyl-3-methylimidazolium chloride, 1-propyl-3-methylimidazolium bromide, 1-butyl-3-methylimidazolium chloride, 1-butyl-3-methylimidazolium bromide, 1-butyl-3-methylimidazolium iodide, 1-butyl-3-methylimidazolium formate, 1-butyl-3-methylimidazolium thiocyanate, 1-butyl-3-methylimidazolium dicyanamide, 1-butyl-3-methylimidazolium acetate, 1-butyl-3-methylimidazolium tetrafluoroborate, 1-butyl-3-methylimidazolium hexfluorophosphate, 1-butyl-3-methylimidazolium trifluoromethanesulfonate, 1-butyl-3-methylimidazolium methylsulfate, 1-butyl-3-methylimidazolium bis[(trifluoromethane)sulfonyl]imide, 1-butyl-2,3-dimethylimidazolium chloride, 1-butyl-2,3-dimethylimidazolium tetrafluoroborate, 1-pentyl-3-methylimidazolium chloride, 1-pentyl-3-methylimidazolium bromide, 1-hexyl-3-methylimidazolium chloride, 1-hexyl-3-methylimidazolium bromide, 1-hexyl-3-methylimidazolium tetrafluoroborate, 1-hexyl-3-methylimidazolium trifluoromethanesulfonate, 1-hexyl-3-methylimidazolium bis[(trifluoromethane)sulfonyl]imide, 1-heptyl-3-methylimidazolium chloride, 1-heptyl-3-methylimidazolium bromide, 1-octyl-3-methylimidazolium chloride, 1-octyl-3-methylimidazolium bromide, 1-octyl-3-methylimidazolium acetate, 1-nonl-3-methylimidazolium chloride, 1-nonyl-3-methylimidazolium bromide, 1-decyl-3-methylimidazolium chloride, 1-benzyl-3-methylimidazolium chloride, 1-benzyl-3-methylimidazolium dicyanamide, 1-(3-methoxybenzyl)-3-methylimidazolium chloride, 1-(3,6-dioxahexyl)-3-methylimidazolium chloride, 1-(3,6-dioxahexyl)-3 methylimidazolium acetate, 1-ethyl-3-(3,6-dioxaheptyl)imidazolium chloride, 1-ethyl-3-(3,6-dioxaheptyl)imidazolium dicyanamide, 1-ethyl-3-(3,6-dioxaheptyl)imidazolium acetate, 1(3,6,9-trioxanoyl)-3-methylimidazolium acetate, 1-ethyl-3-(3,6,9-trioxadecyl)imidazolium acetate, 1-butyl-3-(3,6,9-trioxadecyl)imidazolium acetate, 1-ethyl-3-(4,8,12-trioxatridecyl)imidazolium acetate, 1-ethyl-3(3,6,9,12-tetraoxatridecyl)imidazolium acetate, 1-(3,6-dioxaheptyl)-3-(3,6,9-trioxadecyl)imidazolium acetate, 1-ethyl-3(3,6,9,12,15,18,21-heptaoxadococyl)imidazolium acetate, 3,3′-ethane-1,2-diylbis(1-methyl-1H-imidazol-3-ium)dichloride, 3,3′-ethane-1,2-diylbis(1-methyl-1H-imidazol-3-ium)dichloroaluminate, 1-butyl-1-methylpyrrolidinium chloride, 1-butyl-1-methylpyrrolidinium bis[(trifluoromethane)sulfonyl]imide, 1-butyl-3-methylpyridinium chloride, N.N-dimethylathanolammonium acetate, choline dicyanamide, choline bis[(trifluoromethane)sulfonyl]imide, N.N-dimethyl-2-methoxyethylammonium acetate, N.N-bis(2-methoxyethyl)ammonium acetate, N-methyl-N.N-bis(2-methoxyethyl)ammonium acetate, N.N.N-triethyl-3,6-dioxaheptylammonium acetate, tetrabutylammonium formate, N.N.N-triethyl-3,6,9-trioxadecylammonium formate, N.N.N-triethyl-3,6,9-trioxadecylammonium acetate, N-benzyl-N,N-dimethyltretradecylammonium chloride, tetrabutylphosphonium chloride, tetrabutylphosphonium formate, trihexyltetradecylphosphonium dicyanamide, 1,8-diazabicyclo[5.4.0]undec-7-enium hydrochloride, 1,8-diazabicyclo[5.4.0]undec-7-enium formate, 1,8-diazabicyclo[5.4.0]undec-7-enium acetate, 1,8-diazabicyclo[5.4.0]undec-7-enium thiocyanate, 1,8-diazabicyclo[5.4.0]undec-7-enium hydrogensulfate, 1,8-diazabicyclo[5.4.0]undec-7-enium trifluoroacetate, 1,8-diazabicyclo[5.4.0]undec-7-enium methanesulfonate, 1,8-diazabicyclo[5.4.0]undec-7-enium lactate, 1,8-diazabicyclo[5.4.0]undec7-enium tosylate, 1,8-diazabicyclo[5.4.0]undec-7-enium saccharinate, 1,8-diazabicyclo[5.4.0]undec-7-enium, 8-methyl-1,8-diazabicyclo[5.4.0]undec-7-enium hydrogensulfate, 8-butyl-1,8-diazabicyclo[5.4.0]undec-7-enium chloride, 8-octyl-1,8-diazabicyclo[5.4.0]undec-7-enium chloride or a combination thereof.

In some embodiments, formation of a colloid suspension of biopolymer aggregates comprises the addition of a phase separation solvent to the single phase biopolymer solution. In some embodiments, the phase separation solvent is incrementally added to the single phase biopolymer solution. In some embodiments, the size and amount of the colloids of biopolymer aggregates formed by addition of the phase separation solvent may depend on the rate of addition, the polarity of the phase separation solvent, the terminal total volume percent of the biopolymer colloids of biopolymer aggregates or a combination thereof.

In some embodiments, the phase separation solvent is an aqueous solvent. In some embodiments, the aqueous solvent is water. In some embodiments, the phase separation solvent is an organic solvent. In some embodiments, the organic solvent is selected from ethanol, acetone, cyclohexane, toluene, methylethylketone, benzene, ethylene glycol, cyclopentanone or a combination thereof. In some embodiments, the phase separation solvent may be a combination of water and an organic solvent. In some embodiments, the phase separation solvent is any solvent suitable for electrophoretic deposition. In some embodiments, the phase separation solvent is any solvent capable of supporting an electromotive force. In some embodiments, the phase separation solvent is any solvent capable of supporting an electric current. In some embodiments, the phase separation solvent can be utilized to modify the overall polarity of the colloid suspension of biopolymer aggregates.

In some embodiments, separating the colloid suspension of biopolymer aggregates from the ionic liquid solvent comprises sedimentation, solidification or a combination thereof. In some embodiments, standard methods of sedimentation or solidification can be used.

In some embodiments, the substrate material is capable of supporting an electromotive force. In some embodiments, the substrate is capable of supporting an electric current.

In some embodiments, the substrate is an oxidized metallic substrate. In some embodiments, the oxidized metal substrate comprises an oxide of beryllium, magnesium, calcium, strontium, barium, radium, boron, yttrium, scandium, lithium, titanium, zirconium, hafnium, vanadium, tantalum, chromium, molybdenum, tungsten, manganese, technetium, rhenium, iron, ruthenium, osmium, cobalt, rhodium, iridium, nickel, palladium, platinum, copper, silver, gold, zinc, cadmium, mercury, aluminum, gallium, indium, thallium, tin, lead, and bismuth,

In some embodiments, the substrate is a mold released metal substrate. In some embodiments, the mold released metal substrate comprises a substrate coated with an insulator material. In some embodiments, the insulator material comprises a fluoropolymer.

In some embodiments, electrophoretic deposition of the colloid suspension of biopolymer aggregates onto the substrate comprises immersing the substrate and a counter electrode into the colloid suspension of biopolymer aggregates.

Some embodiments further comprise providing a source of electromotive force wherein the source has a first terminus and a second terminus and wherein an electrical potential exists between the first and the second terminus and wherein the first terminus is contacted to the substrate and wherein the second terminus is contacted to the counter electrode. In some embodiments, the source of electromotive force produces about 20 volts to about 400 volts. In some embodiments, the source of electromotive force produces about 20 volts to about 400 volts. In some embodiments, the source of electromotive force produces about 20 to about 40 volts, about 40 to about 100 volts, about 100 volts to about 200 volts, about 200 volts to about 300 volts or about 300 volts to about 400 volts.

In some embodiments, the counter electrode is biased as an anode and the substrate is biased as a cathode and wherein the colloid suspension of biopolymer aggregates has an overall positive charge resulting in deposition of the colloid suspension of biopolymer aggregates onto the substrate. In some embodiments, the counter electrode is biased as a cathode and the substrate is biased as an anode and wherein the colloid suspension of biopolymer aggregates has an overall negative charge resulting in deposition of the colloid suspension of biopolymer aggregates onto the substrate. In some embodiments, electrophoretic deposition results in formation of Van der Waals bonding, hydrogen bonding or a combination thereof between the biopolymer aggregates and the substrate.

In some embodiments, as the source of electromotive force is applied, the colloids of biopolymer aggregates will drift to the substrate and accumulate on or near the surface of the substrate as a membrane or film. In some embodiments, the membrane or film will adhere to the substrate as an electric field is created that involves the double layer of the substrate surface and the charged colloids of biopolymer aggregates. In some embodiments, the duration time of applied electromotive force will determine the membrane or film thickness. In some embodiments, the greater the duration of time of applied electromotive force, the thicker the membrane or film. In some embodiments, electrophoretic deposition results in formation of Van der Waals bonding, hydrogen bonding or a combination thereof between the biopolymer aggregates and the substrate.

In some embodiments, the thickness of the membranes or films described herein can be about 0.1 micron to about 1,000 microns. In yet other embodiments the thickness of the membranes or films can be about 0.1 microns to about 10 microns, about 10 microns to about 100 microns, about 100 microns to about 200 microns, about 200 microns to about 300 microns, about 300 microns to about 400 microns, or about 400 microns to about 500 microns, about 500 microns to about 600 microns, about 600 microns to about 700 microns, about 700 microns to about 800 microns, about 800 microns to about 900 microns, about 900 microns to about 1,000 microns.

In some embodiments, following electrophoretic deposition of the biopolymer aggregates onto the substrate to form the substrate coated with a deposited colloid suspension of biopolymer aggregates, the substrate coated with a deposited colloid suspension of biopolymer aggregates is removed from the colloid suspension of biopolymer aggregates. Some embodiments further comprise rinsing the substrate coated with a deposited colloid suspension of biopolymer aggregates. Some embodiments further comprise drying the substrate coated with a deposited colloid suspension of biopolymer aggregates. In some embodiments, drying the substrate coated with a deposited colloid suspension of biopolymer aggregates may result in contraction or shrinkage of the engineered hydrophilic biopolymer membrane or film.

In some embodiments, curing the substrate coated with a deposited colloid suspension of biopolymer aggregates comprises heat treating the coated substrate. In some embodiments, the substrate coated with a deposited colloid suspension of biopolymer aggregates may be cured using any technique known in the art, such as, without limitation, thermal energy, infrared, ionizing or actinic radiation, or by any combination thereof. In some embodiments, curing the substrate coated with a deposited colloid suspension of biopolymer aggregates comprises heating the coated substrate to a temperature of up to about 130° C. In some embodiments, curing the substrate coated with a deposited colloid suspension of biopolymer aggregates comprises heating the coated substrate to a temperature of up to about 25° C., about 50° C., about 75° C., or about 100° C. In some embodiments, the substrate coated with a deposited colloid suspension of biopolymer aggregates may cure at ambient temperature and pressure. In some embodiments, curing the substrate coated with a deposited colloid suspension of biopolymer aggregates is carried out for a period of 1 to 72 hours. In some embodiments, curing times be about 1 hour to about 12 hours, about 12 hours to about 24 hours, about 24 hours to about 36 hours, about 36 hours to about 48 hours, about 48 hours to about 60 hours, or about 60 hours to about 72 hours.

In some embodiments, the deposited colloid suspension of biopolymer aggregates may be porous prior to curing due to the formation of gas during the electrophoretic deposition process. In some embodiments, curing the substrate coated with a deposited colloid suspension of biopolymer aggregates results in the formation of crosslinks and allows accumulated gas to flow out of the coating making it smooth and continuous. In some embodiments, curing the substrate coated with a deposited colloid suspension of biopolymer aggregates results in the formation of ether crosslinks between the biopolymer aggregates. In some embodiments, the ether crosslinks are formed between hydroxyl functional end groups and methoxy functional end groups on the biopolymer aggregates. In some embodiments, not all hydroxyl functional end groups form ether crosslinks. In some embodiments, the degree of crosslinking can be about 1% to about 100%, about 1% to about 10%, about 10% to about 50%, or about 50% to about 100% of functional end groups being crosslinked. In some embodiments, water and methanol are by byproducts of the formation of crosslinks between biopolymer aggregates. In some embodiments, ether crosslinks, hydroxyl functional end groups or a combination thereof form make the biopolymer aggregate coating on the substrate hydrophilic. In some embodiments, the formation of ether crosslinks between the biopolymer aggregates may result in contraction or shrinkage of the biopolymer aggregate coating and subsequently of the engineered hydrophilic biopolymer membrane or film.

In some embodiments, peeling away the engineered hydrophilic biopolymer membrane or film from the substrate comprises separating the engineered hydrophilic biopolymer membrane or film from the substrate. In some embodiments, the use of an oxidized or mold-released substrate results in weak adhesion of the engineered hydrophilic biopolymer membrane or film to the substrate. In some embodiments, the weak adhesion permits the engineered hydrophilic biopolymer membrane or film to be peeled away from the substrate.

Some embodiments described herein are directed to a hydrophilic biopolymer coating comprising a cured colloid suspension of biopolymer aggregates. In some embodiments, the biopolymer aggregates comprise lignin, lignosulfonate, cellulose, sulfonated cellulose, hemicellulose, sulfonated hemicellulose, dextrin, sulfonated dextrin, a wood-derived biopolymer, a sulfonated wood-derived biopolymer or a combination thereof. In some embodiments, the biopolymer aggregates have a polydisperse molecular weight of about 500 Daltons to about 500,000 Daltons. In some embodiments, the biopolymer aggregates are bonded to each other via ether crosslinks. In some embodiments, the ether crosslinks are formed between hydroxyl and methoxy functional end groups on the biopolymer aggregates. In some embodiments, the degree of crosslinking can be about 1% to about 100%, about 1% to about 10%, about 10% to about 50%, or about 50% to about 100% of functional end groups being crosslinked.

Some embodiments described herein are directed to a substrate coated with a hydrophilic biopolymer coating comprising a cured colloid suspension of biopolymer aggregates. In some embodiments, the biopolymer aggregates have a polydisperse molecular weight of about 500 Daltons to about 500,000 Daltons. In some embodiments, the biopolymer aggregates are bonded to the substrate via Van der Waals bonding, hydrogen bonding or a combination thereof. In some embodiments, the biopolymer aggregates are bonded to each other via ether crosslinks. In some embodiments, the ether crosslinks are formed between hydroxyl and methoxy functional end groups on the biopolymer aggregates. In some embodiments, the degree of crosslinking can be about 1% to about 100%, about 1% to about 10%, about 10% to about 50%, or about 50% to about 100% of functional end groups being crosslinked.

In some embodiments, the substrate is capable of supporting an electromotive force. In some embodiments the substrate is capable of supporting an electric current.

In some embodiments, the substrate is a metallic substrate comprising at least one of copper, annealed copper, aluminum, tungsten, nickel, platinum, gold, silver, brass, bronze, iron, steel, stainless steel, grain oriented electrical steel, lead, lithium, tin, titanium, mercury, cadmium, manganin, constatan, nichrome, or a combination thereof.

In some embodiments, the substrate is a semiconductor comprising at least one of selenium, germanium, carbon, silicon, silicon carbide, aluminum antimonide, aluminum nitride, boron nitride, boron arsenide, gallium arsenide, gallium nitride, gallium phosphide, gallium antimonide, indium nitride, indium phosphide, indium antimonide, aluminum gallium arsenide, indium gallium arsenide, indium gallium phosphide, aluminum indium arsenide, aluminum indium antimonide, gallium arsenide nitride, gallium arsenide phosphide, gallium arsenide antimonide, aluminum gallium nitride, aluminum gallium phosphide, indium arsenide antimonide, indium gallium antimonide, aluminum gallium indium phosphide, aluminum gallium arsenide phosphate, indium gallium arsenide phosphide, indium gallium arsenide antimonide, indium arsenide antimonide phosphide, aluminum indium arsenide phosphide, aluminum gallium arsenide nitride, indium, gallium arsenide nitride, indium aluminum arsenide nitride, gallium arsenide antimonide nitride, gallium indium nitride arsenide antimonide, gallium indium arsenide antimonide phosphide, cadmium selenide, cadmium sulfide, cadmium telluride, zinc oxide, zinc selenide, zinc sulfide, zinc telluride, cadmium zinc telluride, mercury zinc telluride mercury zinc selenide, cuprous chloride, copper sulfide, lead selenide, lead(II) sulfide, lead telluride, lead tine telluride, thallium germanium telluride, bismuth telluride, cadmium phosphide, cadmium arsenide, cadmium antimonide, zinc phosphide, zinc arsenide, zinc antimonide, titanium dioxide, copper oxide, uranium dioxide uranium trioxide, bismuth trioxide, tin dioxide, barium titanate, strontium titanate, lithium niobate, lanthanum copper oxide, lead(II) iodide, molybdenum disulfide, gallium selenide, tin sulfide, bismuth sulfide, gallium manganese arsenide, indium manganese telluride, lanthanum calcium manganite, Iron(II) oxide, nickel(II) oxide, europium (II) oxide, europium(II) sulfide, chromium(III) bromide, copper indium gallium selenide, copper zinc tin sulfide, copper indium selenide, silver gallium sulfide, zinc silicon phosphide, arsenic sulfide, platinum silicide, bismuth(III) iodide, mercury(II) iodide, thallium(I) bromide, silver sulfide, iron disulfide, or a combination thereof.

In some embodiments, the thickness of the coatings described herein can be about 0.1 micron to about 1,000 microns. In yet other embodiments the thickness of the coatings can be about 0.1 microns to about 10 microns, about 10 microns to about 100 microns, about 100 microns to about 200 microns, about 200 microns to about 300 microns, about 300 microns to about 400 microns, or about 400 microns to about 500 microns, about 500 microns to about 600 microns, about 600 microns to about 700 microns, about 700 microns to about 800 microns, about 800 microns to about 900 microns, about 900 microns to about 1,000 microns.

In some embodiments, the hydrophilic biopolymer coating is a membrane, a film or a combination thereof. In some embodiments, the thickness of the membranes or films described herein can be about 0.1 micron to about 1,000 microns. In yet other embodiments the thickness of the coatings can be about 0.1 microns to about 10 microns, about 10 microns to about 100 microns, about 100 microns to about 200 microns, about 200 microns to about 300 microns, about 300 microns to about 400 microns, or about 400 microns to about 500 microns, about 500 microns to about 600 microns, about 600 microns to about 700 microns, about 700 microns to about 800 microns, about 800 microns to about 900 microns, about 900 microns to about 1,000 microns.

In some embodiments, the hydrophilic biopolymer coatings, films and membranes can be used as a protective coating for a conductive substrate. In some embodiments, the coating film or membrane can be formed directly onto the conductive substrate by electrophoretic deposition. In some embodiments, the hydrophilic biopolymer coatings, films and membranes can be used as a protective coating for a non-conductive substrate wherein the coating, film or membrane is applied to the substrate after it is formed.

In some embodiments, the coatings, films and membranes described herein, may be used as barriers to humidity, oxygen or a combination thereof. In some embodiments, the coatings, films and membranes described herein may protect the surface on which they are applied from humidity exposure, oxygen exposure or a combination thereof. In some embodiments, the coatings, films and membranes may provide protection from corrosion resulting from exposure to humidity oxygen or a combination thereof. In yet other embodiments, the coatings, films and membranes provide protection from oxidation resulting from exposure to humidity, oxygen or a combination thereof.

In some embodiments, the hydrophilic biopolymer coatings, films and membranes can be used to produce smooth, hard, slick coatings. In some embodiments, such coatings, films and membranes provide resistance to corrosion by chemicals that would otherwise corrode the coated surface.

In some embodiments, the hydrophilic biopolymer coatings, films and membranes described herein provide benefits to the coated surface such as, but not limited to, reduced friction, corrosion resistance, chemical resistance, resistance to galling, non-stick properties, non-wetting, electrical resistance, abrasion resistance, salt spray resistance, increased impact strength, increased hardness, or combinations thereof.

In some embodiments, the hydrophilic biopolymer coatings, films and membranes described herein may be used filters, osmosis membranes or a combination thereof in application such as but not limited to large scale water or waste treatment. In some embodiments, the hydrophilic biopolymer coatings, films and membranes described herein may be used as weather resistant coatings in applications such as but not limited to construction materials, outdoor furniture, tools and outdoor structures.

In some embodiments, the hydrophilic biopolymer coatings, films and membranes described herein may be biodegradable. The biopolymers described herein are based on naturally occurring polymer such as lignin, lignosulfonate, cellulose, sulfonated cellulose, hemicellulose, sulfonated hemicellulose, dextrin, sulfonated dextrin, a wood-derived biopolymer, a sulfonated wood-derived biopolymer, or a combination thereof, it follows that these biopolymers will be naturally broken down in a similar way when exposed to suitable conditions. In some embodiments, the hydrophilic biopolymer coatings films and membranes make use of materials such as but not limited to lignin and other wood derived biopolymers that would otherwise be disposed of in the paper pulping industries. In yet other embodiments, the hydrophilic biopolymer coatings films and membranes are an example of the responsible use of natural wood resources.

In some embodiments, the hydrophilic biopolymer coatings, films and membranes may be porous. In some embodiments, the hydrophilic biopolymer coatings, films and membranes may be porous if they are not cured after electrophoretic deposition onto a conductive substrate. In yet other embodiments, the hydrophilic biopolymer coatings, films and membranes described herein may be used to control diffusion and transport of particles in a variety of chemical processes.

In some embodiments the biopolymer can be modified so as to confer additional functionality to the hydrophilic biopolymer coatings, films and membranes described herein. In some embodiments, additional molecules such as, but not limited, antimicrobial agents, biocidal agents, carbohydrates, sugars, bulking agents, dyes, hydrophobic agents, hydrophilic agents, ionic surfactants, non-ionic surfactants, peptides, proteins, biomolecules, lipids, lipid bilayers or combinations thereof may be covalently linked to the biopolymer via Mitsonobu coupling and click-chemistry as well as other suitable chemical linking reactions.

While specific embodiments of the invention have been described in details, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof. Various aspects of the present embodiments will be illustrated with reference to the following non-limiting examples.

### EXAMPLES

### Example 1

### Process of Coating a Conductive Substrate with a Hydrophilic Lignin Coating

A conductive substrate can be coated with hydrophilic lignin coating via a multi-step process. In a first step, a batch of lignin (extracted from pine Kraft pulp) is dissolved in 1,3,dimethylimidazolium methylsulfate at room temperature and pressure in a glass vessel. The dissolved lignin and 1,3,dimethylimidazolium methylsulfate are expected to form a single phase solution.

In a second step, phase separation is induced by the incremental addition of water to the dissolved lignin. The addition of water is expected to result in formation of a water phase and a 1,3,dimethylimidazolium methylsulfate phase with aggregation of the lignin to form a colloidal suspension of lignin aggregates in a water phase.

In a third step, the colloidal suspension of lignin aggregates in the water phase is separated from the 1,3,dimethylimidazolium methylsulfate phase by sedimentation.

In a fourth step, the colloidal suspension of lignin aggregates in the water phase is added to an electrophoretic deposition bath followed by immersion of the conductive substrate to be coated and a counter electrode biased as an anode. The conductive substrate is biased as a cathode and the colloid suspension of lignin aggregates has an overall positive charge. Upon application of a 100V electric current, the conductive substrate becomes coated with the colloid suspension of lignin aggregates. Once a coating of the desired thickness is obtained, the electric current is discontinued and the now coated conductive substrate is removed from the electrophoretic deposition bath.

The coated conductive substrate is then rinsed and cleaned with water and allowed to dry at room temperature and pressure. In fifth and final step, the now dry coated conductive substrate is placed in an oven at 130° C. for about 12 hours to about 24 hours. The process of curing the coated conductive substrate results in the formation of ether crosslinks between the hydroxyl and methoxy functional end groups on the lignin aggregates resulting in the formation of a hydrophilic coating on the conductive substrate.

### Example 2

### Process of Coating a Conductive Substrate with a Hydrophilic Lignin Coating

A conductive substrate can be coated with hydrophilic lignin coating via a multi-step process. In a first step, a batch of lignin (extracted from pine Kraft pulp) is dissolved in 1-hexyl-3-methylimidazolium trifluoromethanesulfonate at room temperature and pressure in a glass vessel. The dissolved lignin and 1-hexyl-3-methylimidazolium trifluoromethanesulfonate are expected to form a single phase solution.

In a second step, phase separation is induced by the incremental addition of cyclohexane to the dissolved lignin. The addition of cyclohexane is expected to result in formation of an organic phase and an 11-hexyl-3-methylimidazolium trifluoromethanesulfonate phase with aggregation of the lignin to form a colloidal suspension of lignin aggregates in an organic phase.

In a third step, the colloidal suspension of lignin aggregates in the organic phase is separated from the 1-hexyl-3-methylimidazolium trifluoromethanesulfonate phase by sedimentation.

In a fourth step, the colloidal suspension of lignin aggregates in the organic phase is added to an electrophoretic deposition bath followed by immersion of the conductive substrate to be coated and a counter electrode biased as an anode. The conductive substrate is biased as a cathode and the colloid suspension of lignin aggregates has an overall positive charge. Upon application of a 100V electric current, the conductive substrate becomes coated with the colloid suspension of lignin aggregates. Once a coating of the desired thickness is obtained, the electric current is discontinued and the now coated conductive substrate is removed from the electrophoretic deposition bath.

The coated conductive substrate is then rinsed and cleaned with water and allowed to dry at room temperature and pressure. In fifth and final step, the now dry coated conductive substrate is placed in an oven at 130° C. for about 12 hours to about 24 hours. The process of curing the coated conductive substrate results in the formation of ether crosslinks between the hydroxyl and methoxy functional end groups on the lignin aggregates, resulting in the formation of a hydrophilic coating on the conductive substrate.

### Example 3

### Process of Forming a Hydrophilic Lignin Membrane

A hydrophilic lignin membrane can be formed via a multi-step process. In a first step, a batch of lignin (extracted from pine Kraft pulp) is dissolved in 1,3,dimethylimidazolium methylsulfate at room temperature and pressure in a glass vessel. The dissolved lignin and 1,3,dimethylimidazolium methylsulfate are expected to form a single phase solution.

In a second step, phase separation is induced by the incremental addition of water to the dissolved lignin. The addition of water is expected to result in formation of a water phase and a 1,3,dimethylimidazolium methylsulfate phase with aggregation of the lignin to form a colloidal suspension of lignin aggregates in a water phase.

In a third step, the colloidal suspension of lignin aggregates in the water phase is separated from the 1,3,dimethylimidazolium methylsulfate phase by sedimentation.

In a fourth step, the colloidal suspension of lignin aggregates in the water phase is added to an electrophoretic deposition bath followed by immersion of an oxidized copper plate to be coated and a counter electrode biased as an anode. The oxidized copper plate is biased as a cathode and the colloid suspension of lignin aggregates has an overall positive charge. Upon application of a 100V electric current, the oxidized copper plate becomes coated with the colloid suspension of lignin aggregates to form a membrane on the oxidized copper plate. Once a membrane of the desired thickness is obtained, the electric current is discontinued and the membrane-coated oxidized copper plate is removed from the electrophoretic deposition bath.

The membrane-coated oxidized copper plate is then rinsed and cleaned with water and allowed to dry at room temperature and pressure. In fifth step, the dry membrane-coated oxidized copper plate is placed in an oven at 130° C. for about 12 hours to about 24 hours. The process of curing the coated conductive substrate results in the formation of ether crosslinks between the hydroxyl and methoxy functional end groups on the lignin aggregates resulting in the formation of a hydrophilic coating on the conductive substrate.

In a sixth and final step, the membrane is carefully peeled away from the oxidized copper plate. The membrane can then be shaped or further modified for its specific application.

### Example 4

### Process for Coating a Metal Structural Beam with a Hydrophilic Lignin Coating

Structural beams are often made from metals such as steel and iron. These metals are extremely strong but unless they are treated appropriately they are subject to corrosion by chemicals, humidity, water and oxygen. A metal structural beam can be coated with hydrophilic lignin coating via a multi-step process. The coating of the metal structural beam may protect the beam from direct exposure to chemicals, oxygen, water, and humidity and protect the metal from corrosion. In a first step, a batch of lignin (extracted from pine Kraft pulp) is dissolved in 1-hexyl-3-methylimidazolium trifluoromethanesulfonate at room temperature and pressure in a glass vessel. The dissolved lignin and 1-hexyl-3-methylimidazolium trifluoromethanesulfonate are expected to form a single phase solution.

In a second step, phase separation is induced by the incremental addition of cyclohexane to the dissolved lignin. The addition of cyclohexane is expected to result in formation of an organic phase and an 11-hexyl-3-methylimidazolium trifluoromethanesulfonate phase with aggregation of the lignin to form a colloidal suspension of lignin aggregates in an organic phase.

In a third step, the colloidal suspension of lignin aggregates in the organic phase is separated from the 1-hexyl-3-methylimidazolium trifluoromethanesulfonate phase by sedimentation.

In a fourth step, the colloidal suspension of lignin aggregates in the organic phase is added to an electrophoretic deposition bath followed by immersion of the metal structural beam to be coated and a counter electrode biased as an anode. The conductive substrate is biased as a cathode and the colloid suspension of lignin aggregates has an overall positive charge. Upon application of a 100V electric current, the conductive substrate becomes coated with the colloid suspension of lignin aggregates. Once a coating of the desired thickness is obtained, the electric current is discontinued and the now coated metal structural beam is removed from the electrophoretic deposition bath.

The coated conductive metal structural beam is then rinsed and cleaned with water and allowed to dry at room temperature and pressure. In fifth and final step, the now dry coated conductive substrate is placed in an oven at 130° C. for about 12 hours to about 24 hours. The process of curing the coated metal structural beam results in the formation of ether crosslinks between the hydroxyl and methoxy functional end groups on the lignin aggregates resulting in the formation of a hydrophilic coating on the conductive substrate.

1. A method of coating a substrate with a biopolymer coating, the method comprising:
dissolving a biopolymer in an ionic liquid solvent to form a single phase biopolymer solution;
adding a phase separation solvent to the single phase biopolymer solution to form a colloid suspension of biopolymer aggregates;
separating the colloid suspension of biopolymer aggregates from the ionic liquid solvent;
depositing the biopolymer aggregates onto the substrate to form a coated substrate; and
curing the coated substrate.

2. The method of claim 1, wherein dissolving the biopolymer comprises dissolving a biopolymer selected from the group consisting of lignin, lignosulfonate, cellulose, sulfonated cellulose, hemicellulose, sulfonated hemicellulose, dextrin, sulfonated dextrin, a wood-derived biopolymer, a sulfonated wood-derived biopolymer and a combination thereof in the ionic liquid solvent.

3. The method of claim 1, wherein dissolving the biopolymer comprises dissolving the biopolymer in the ionic liquid solvent comprising at least one di-functionalized imidazolium salt.

4. (canceled)

5. The method of claim 1, wherein depositing the biopolymer aggregates comprises depositing the biopolymer aggregates onto a metallic substrate selected from the group consisting of copper, annealed copper, aluminum, tungsten, nickel, platinum, gold, silver, brass, bronze, iron, steel, stainless steel, grain oriented electrical steel, lead, lithium, tin, titanium, mercury, cadmium, manganin, constatan, nichrome and a combination thereof.

6-10. (canceled)

11. The method of claim 1, wherein adding the phase separation solvent comprises adding an aqueous solvent or an organic solvent.

12-14. (canceled)

15. The method of claim 1, wherein separating the colloid suspension of biopolymer aggregates from the ionic liquid solvent comprises sedimentation, solidification or a combination thereof.

16. The method of claim 1, wherein depositing the biopolymer aggregates onto the substrate comprises electrophoretic deposition.

17. The method of claim 16, wherein electrophoretic deposition comprises immersing the substrate and a counter electrode into the colloid suspension of biopolymer aggregates.

18-23. (canceled)

24. The method of claim 1, further comprising rinsing the coated substrate and drying the coated substrate.

25. (canceled)

26. The method of claim 1, wherein curing the coated substrate comprises heat treating the coated substrate.

27-28. (canceled)

29. A method of producing a hydrophilic biopolymer membrane, the method comprising:
dissolving a biopolymer in an ionic liquid solvent to form a single phase biopolymer solution;
adding a phase separation solvent to the single phase biopolymer solution to form a colloid suspension of biopolymer aggregates;
separating the colloid suspension of biopolymer aggregates from the ionic liquid solvent;
depositing the biopolymer aggregates onto the substrate to form a substrate coated with a deposited colloid suspension of biopolymer aggregates;
curing the substrate coated with a deposited colloid suspension of biopolymer aggregates to form the hydrophilic biopolymer membrane; and
peeling away the hydrophilic biopolymer membrane from the substrate.

30. The method of claim 29, wherein dissolving the biopolymer comprises dissolving a biopolymer selected from the group consisting of lignin, lignosulfonate, cellulose, sulfonated cellulose, hemicellulose, sulfonated hemicellulose, dextrin, sulfonated dextrin, a wood-derived biopolymer, a sulfonated wood-derived biopolymer and a combination thereof in the ionic solvent.

31-33. (canceled)

34. The method of claim 29, wherein depositing the biopolymer comprises depositing the biopolymer aggregates onto an oxidized metallic substrate.

35. The method of claim 34 wherein depositing the biopolymer comprises depositing the biopolymer aggregates onto the oxidized metal substrate selected from the group consisting of an oxide of beryllium, magnesium, calcium, strontium, barium, radium, boron, yttrium, scandium, lithium, titanium, zirconium, hafnium, vanadium, tantalum, chromium, molybdenum, tungsten, manganese, technetium, rhenium, iron, ruthenium, osmium, cobalt, rhodium, iridium, nickel, palladium, platinum, copper, silver, gold, zinc, cadmium, mercury, aluminum, gallium, indium, thallium, tin, lead, and bismuth,

36-59. (canceled)

60. A hydrophilic biopolymer coating comprising a cured colloid suspension of biopolymer aggregates.

61. The coating of claim 60, wherein the biopolymer aggregates comprise lignin, lignosulfonate, cellulose, sulfonated cellulose, hemicellulose, sulfonated hemicellulose, dextrin, sulfonated dextrin, a wood-derived biopolymer, a sulfonated wood-derived biopolymer or a combination thereof.

62. The coating of claim 60, wherein the biopolymer aggregates have a polydisperse molecular weight of about 500 daltons to about 500,000 daltons.

63. The coating of claim 60, wherein the biopolymer aggregates are bonded to each other via ether crosslinks.

64. A substrate coated with a hydrophilic biopolymer coating comprising a cured colloid suspension of biopolymer aggregates.

65. The substrate coated with a hydrophilic biopolymer coating of claim 64 wherein the substrate is capable of supporting an electric current.

66. The substrate coated with a hydrophilic biopolymer coating of claim 64, wherein the biopolymer aggregates are bonded to the substrate via Van der Waals bonding, hydrogen bonding or a combination thereof.

67. The substrate coated with a hydrophilic biopolymer coating of claim 64, wherein the substrate is a metallic substrate comprising at least one of copper, annealed copper, aluminum, tungsten, nickel, platinum, gold, silver, brass, bronze, iron, steel, stainless steel, grain oriented electrical steel, lead, lithium, tin, titanium, mercury, cadmium, manganin, constatan, nichrome or a combination thereof.

68. The substrate coated with a hydrophilic biopolymer coating of claim 64, wherein the substrate is a semiconductor comprising at least one of selenium, germanium, carbon, silicon, silicon carbide, aluminum antimonide, aluminum nitride, boron nitride, boron arsenide, gallium arsenide, gallium nitride, gallium phosphide, gallium antimonide, indium nitride, indium phosphide, indium antimonide, aluminum gallium arsenide, indium gallium arsenide, indium gallium phosphide, aluminum indium arsenide, aluminum indium antimonide, gallium arsenide nitride, gallium arsenide phosphide, gallium arsenide antimonide, aluminum gallium nitride, aluminum gallium phosphide, indium arsenide antimonide, indium gallium antimonide, aluminum gallium indium phosphide, aluminum gallium arsenide phosphate, indium gallium arsenide phosphide, indium gallium arsenide antimonide, indium arsenide antimonide phosphide, aluminum indium arsenide phosphide, aluminum gallium arsenide nitride, indium, gallium arsenide nitride, indium aluminum arsenide nitride, gallium arsenide antimonide nitride, gallium indium nitride arsenide antimonide, gallium indium arsenide antimonide phosphide, cadmium selenide, cadmium sulfide, cadmium telluride, zinc oxide, zinc selenide, zinc sulfide, zinc telluride, cadmium zinc telluride, mercury zinc telluride mercury zinc selenide, cuprous chloride, copper sulfide, lead selenide, lead(II) sulfide, lead telluride, lead tine telluride, thallium germanium telluride, bismuth telluride, cadmium phosphide, cadmium arsenide, cadmium antimonide, zinc phosphide, zinc arsenide, zinc antimonide, titanium dioxide, copper oxide, uranium dioxide uranium trioxide, bismuth trioxide, tin dioxide, barium titanate, strontium titanate, lithium niobate, lanthanum copper oxide, lead(II) iodide, molybdenum disulfide, gallium selenide, tin sulfide, bismuth sulfide, gallium manganese arsenide, indium manganese telluride, lanthanum calcium manganite, Iron(II) oxide, nickel(II) oxide, europium (II) oxide, europium(II) sulfide, chromium(III) bromide, copper indium gallium selenide, copper zinc tin sulfide, copper indium selenide, silver gallium sulfide, zinc silicon phosphide, arsenic sulfide, platinum silicide, bismuth(III) iodide, mercury(II) iodide, thallium(I) bromide, silver sulfide and iron disulfide or a combination thereof.

69. The substrate coated with a hydrophilic biopolymer coating of claim 64, wherein the hydrophilic biopolymer coating is a membrane, a film or a combination thereof.
